(19) United States
(12) Patent Application Publication
(10) Pub. No.: US 2004/0086255 A1
(43) Pub. Date: May 6, 2004

(54) Stacked optical fiber arrays

(76) Inventors: Alfred D. Botet, Painted Post, NY (US); Stephen J. Caracci, Corning, NY (US); Adam J. Fusco, Painted Post, NY (US); Daniel R. Sempolinski, Painted Post, NY (US)

Correspondence Address: CORNING INCORPORATED, SP-TI-3-1, CORNING, NY, 14831

(21) Appl. No.: 10/284,942

(22) Filed: Oct. 31, 2002

(51) Int. Cl. G02B 6/00

(52) U.S. Cl. 385/137

(57) ABSTRACT

Articles and methods for providing stacked arrays of optical fibers are disclosed. The articles and methods include providing arrays of gripping elements that provide arrays of channels adapted to secure optical fibers to a substrate surface. The articles and methods are useful for making stacked arrays of optical fibers and manufacturing optical devices.

### FIELD OF THE INVENTION

This invention relates to stacked arrays of optical fibers and methods of manufacturing stacked optical fiber arrays and devices including such arrays.

### BACKGROUND OF THE INVENTION

Aligning arrays of optical fibers typically involves placing fibers in V-grooves formed in silicon substrates. Silicon V-grooves can be formed by micromachining, etching or other techniques to accurately align the grooves along the crystal planes of a silicon substrate. Typically, V-groove fiber arrays are made by placing optical fibers in V-grooves of a substrate, placing a lid on the fibers, and then securing the assembly with adhesive. The lid can be a substrate containing V-grooves or a flat silicon or glass plate. The adhesive is typically an ultraviolet-curable or heat-curable epoxy. Stacked arrays of fibers can be formed by stacking the substrates containing v-grooves holding arrays of optical fibers. Limitations of V-groove technology include limited substrate materials, assembly time, fabrication tolerance, and the requirement of adhesives to complete assembly.

One particular example of a problem associated with the use of adhesives is that it can be difficult to position optical fibers in conventional V-grooves because adhesive flows into the small spaces between the fibers and V-grooves. Since the adhesive flows into these spaces, the entire length of the fiber is secured to the V-groove chip in a single step. It is not possible to secure the fiber in the V-groove in multiple gluing steps. This is a problem for certain fiber arrays because multiple gluing steps can improve the alignment of optical fibers.

It would be desirable to provide methods and articles for forming stacked arrays of optical fibers.

### SUMMARY

Certain embodiments of the invention relate to methods and articles for forming stacked arrays of optical fibers. The various embodiments of the present invention provide relatively simple and inexpensive methods and articles for forming stacked arrays of optical fibers. The methods and articles do not require adhesives for securing the fibers to substrates. It is to be understood that both the foregoing general description and the following detailed description are exemplary and are intended to provide further explanation of the invention as claimed.

### BRIEF DESCRIPTION OF THE DRAWINGS

FIG. 1 is a perspective view of a substrate including a plurality of gripping elements and spacers used to make a stacked optical fiber array according to one embodiment of the invention;

FIG. 2 is a partial perspective view of an assembled article for forming a stacked fiber array according to one embodiment of the invention;

FIG. 3 is a top view of one half of a an article for forming a stacked fiber array according to one embodiment of the invention; and

FIG. 4 is a top view of one half of an article for forming a stacked fiber array according to another embodiment of the invention;

FIG. 5 is a perspective view of a substrate including a plurality of gripping elements used to make a stacked optical fiber array according to one embodiment of the invention;

FIG. 6 is a partial perspective view of an assembled stacked optical fiber array according to one embodiment of the invention; and

FIG. 7 is a partial perspective view of an assembled stacked optical fiber array according to one embodiment of the invention.

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

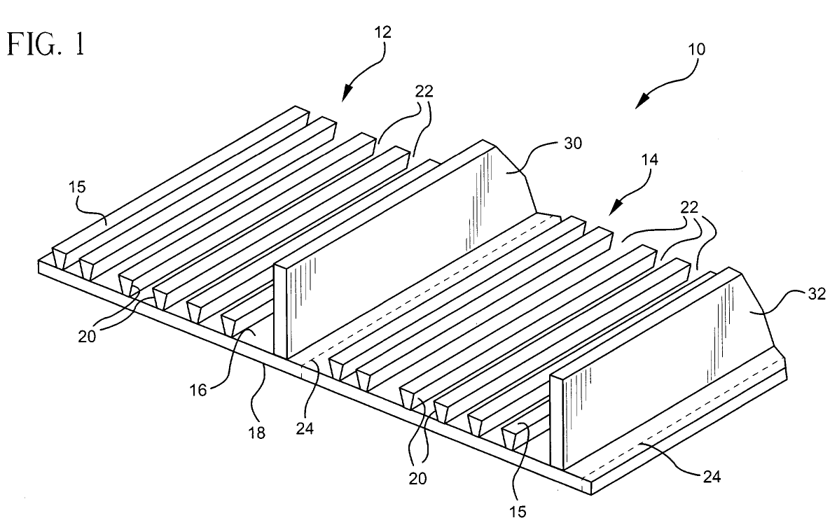

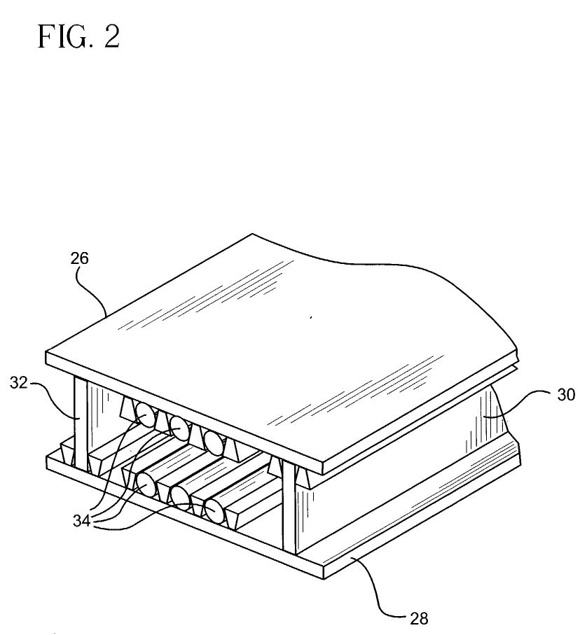

The various embodiments of the present invention relate to articles and methods for providing stacked arrays of optical fibers. According to one embodiment of the invention, an exemplary device for forming stacked optical fiber arrays 10 is shown in FIGS. 1-2. FIG. 1 shows an article for forming a stacked fiber array 10 prior to assembly and which includes a first array of gripping elements 12 and a second array of gripping elements 14 arranged on a surface 16 of a substrate 18. Each gripping element includes at least a pair of flexible sidewalls 20 defining a channel 22, and each array of gripping elements forms a plurality of channels 22 on the surface 16 of the substrate 18 adapted to hold optical fibers. FIG. 1 illustrates two arrays of gripping elements 12, 14 on a single substrate 18. It will be appreciated, of course, that although the articles shown in FIGS. 1 and 2 depict two arrays of grippers providing three pairs of grippers and channels, the invention is not limited to any particular number of channels and grippers formed on the surface of the substrate.

According to the embodiment shown in FIGS. 1 and 2, each section 26, 28 includes a spacer element 30, 32. After the arrays 12, 14 of gripping elements 15 are formed on the substrate 18, the substrate can be cut into sections 26, 28 along cut lines 24, providing complementary sections. As shown in FIG. 2, a pair of sections 26, 28, having optical fibers 34 secured in the channels 22, are secured together. According to the embodiment shown in FIG. 2, the spacer elements 30 and 32 can be secured to channels 22 adapted to receive the spacer elements 30, 32. According to some embodiments, the spacer elements and the gripping elements are made from the same material. The spacer elements and the gripping elements may be made from different materials in alternate embodiments. After the sections 26, 28 have been secured together, a stacked fiber array 10 is provided that includes a first array of fibers and a second array of fibers arranged in a stacked and spaced apart relation. In FIG. 2, the arrays of gripping elements on each substrate are arranged in a stacked apart and opposed relationship.

In the embodiment shown in FIG. 2, a 3×2 array of fibers is shown. It will be appreciated that a wide variety of stacked arrays can be manufactured according to the various embodiments of the present invention. By stacking two stacked arrays of the type shown in FIG. 2, for example, a 3×4 array of optical fibers could be provided. As mentioned above, the number of gripping elements on each section could be increased to increase the number of channels for holding optical fibers. It will also be understood that while the Figures show optical fibers, the invention can include articles adapted to secure optical fibers attached other optical elements, for example, lenses. The articles of the present invention could be used to provide stacked arrays of optical fibers including lenses integrally formed on at least one end of the fibers.

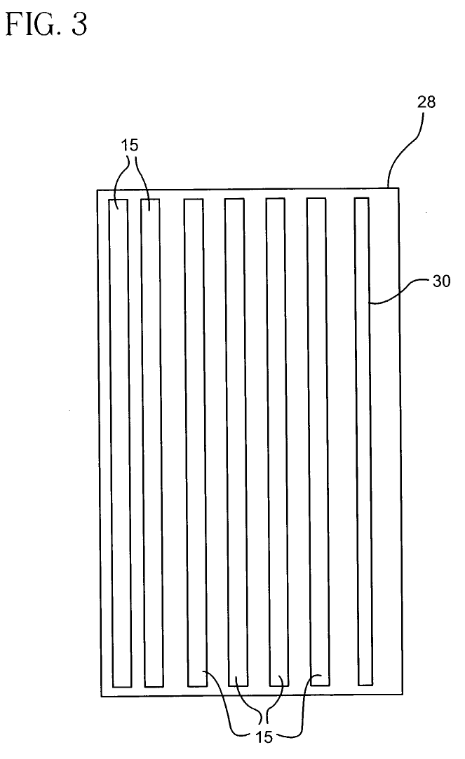

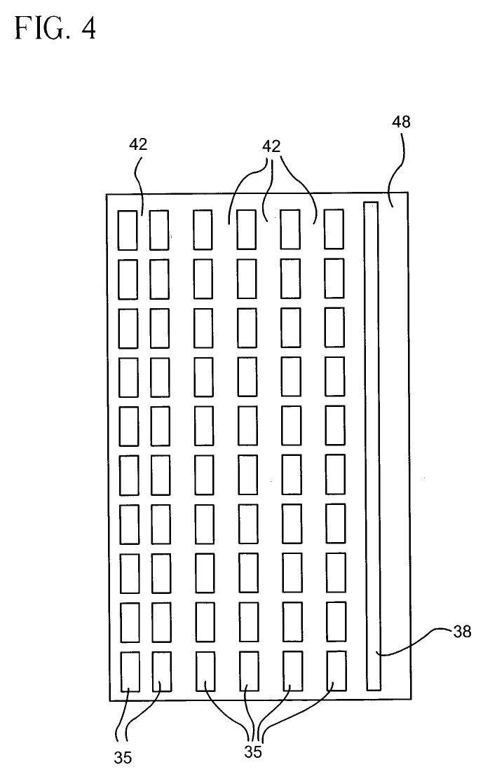

The embodiments shown in FIGS. 1 and 2 depict gripping elements 15 comprised of a unitary strip of material. A top view of one section 28 is shown in FIG. 3. Each pair of gripping elements 15 comprising a pair of unitary strips of material. The spacer 30 comprises a unitary strip of material. In an alternative embodiment shown in FIG. 4, gripping elements 35 can include segmented sections of material on a substrate 40 with a spacer element 38. The segmented sections are linearly arranged to provide a series of generally parallel channels adapted to receive arrays of optical fibers (not shown).

According to certain embodiments, each gripping element includes at least a pair of flexible, generally trapezoidally shaped members. Flexible gripping elements are disclosed in U.S. Pat. Nos. 6,266,472 and 5,359,687. Gripping elements or grippers are versatile structures that can be fabricated from flexible polymeric materials. An example of one way to manufacture grippers includes photolithographic processes, which can be used to form grippers on a variety of substrates. Grippers eliminate the need for extraneous holders to maintain fiber position during assembly, and fibers easily snap into place without the need for adhesives to hold the fibers in place. The substrate onto which the gripping elements are formed can be made from a variety of materials, including but not limited to a single crystal material, silicon, a metal, a polymer, glass, ceramics and combinations of these materials.

Details on the construction of gripping elements are described in U.S. Pat. Nos. 6,266,472 and 5,359,687, both of which are incorporated herein by reference. In U.S. Pat. No. 5,359,687, the gripping elements, which are also called polymer microstructures, are formed on a substrate and used to grip optical fibers and position these fibers with respect to a waveguide disposed on the substrate. U.S. Pat. No. 6,266,472 describes polymer gripping elements that are used in splicing optical fibers.

Gripping elements can be manufactured by depositing strips of material on the surface of the substrate. The strips that make up the gripping elements can be formed using well-known lithographic processes using photopolymerizable compositions and the like. For example, a photopolymerizable composition can be substantially uniformly deposited on onto a substrate surface. The photopolymerizable composition is then imagewise exposed to actinic radiation using a laser and a computer-controlled stage to expose precise areas of the composition with an ultraviolet laser beam, or a collimated UV lamp together with a photomask having a pattern of substantially transparent and substantially opaque areas. The nonimaged areas can then be removed with solvent, while leaving the imaged areas in the form of at least one gripping element on the substrate surface.

Alternatively, flexible strips can be formed by using a soft, flexible embossing tool to pattern the polymerizable composition in the form of at least one gripping element on the substrate surface. Such soft tooling is commonly made with silicones. The composition is then cured and the tool is removed. The flexibility of the tool must be sufficient so that it can be removed from the cured polymer without damaging the grippers. The polymerizable composition may be cured by various means such as actinic radiation or heat, and should have the viscosity to conform to the raised features of the tool. After removing the tool from the cured composition, at least one gripping element will remain on the substrate, depending on the nature of the pattern. The pattern of the tool may include a plurality of gripping elements to provide a substrate for aligning an array of fiber and lenses. Suitable polymeric compositions for making the gripping elements are disclosed in commonly assigned U.S. Pat. No. 6,266,472.

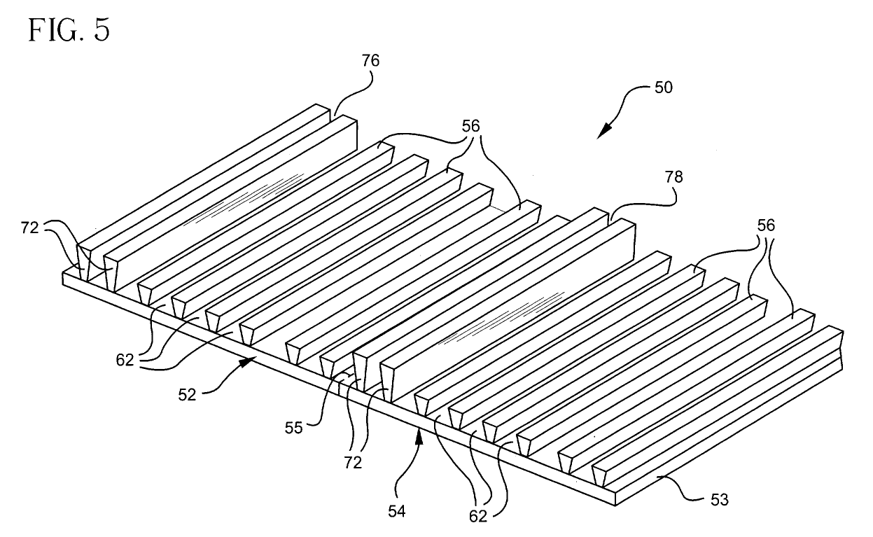

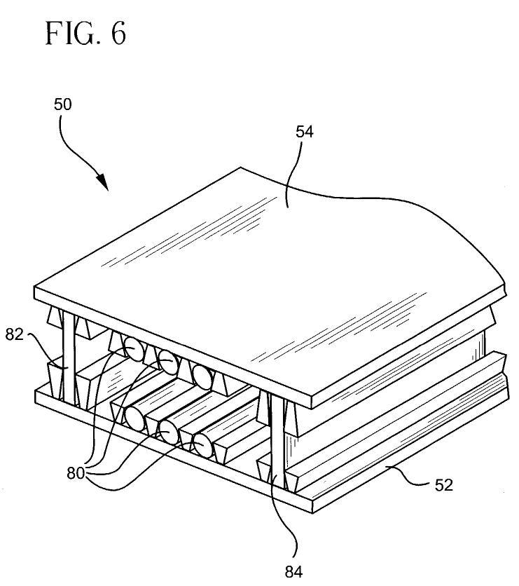

An alternative embodiment is shown in FIGS. 5 and 6. According to the embodiment shown in FIGS. 5 and 6, an article 50 for forming a stacked fiber array includes complementary sections 52, 54. Each section 52, 54 includes a plurality of gripping elements 56 formed on a surface 58 of a substrate 60. A pair of gripping elements 56 defines generally parallel channels 62 adapted to receive optical fibers 80 (shown in FIG. 2). Each section also includes a pair of spacer gripping elements 72, 74 including at least a pair of flexible sidewalls that define channels 76, 78 adapted to receive spacer elements 82, 84 (shown in FIG. 2) having first and second ends. In the embodiment shown in FIG. 5, a pair of complementary sections 52, 54 are formed on a single substrate 53, and the sections are separated at cut line 55. It will be appreciated that larger numbers of sections could be formed on a single substrate to aid in mass production of articles for forming fiber arrays. Alternatively, in certain embodiments, it may be desirable to form a single array of fiber gripping elements and a pair of spacer elements on a single substrate.

As shown in FIG. 6, the sections 52, and 54 are arranged in a generally opposed and spaced apart relationship. Spacer elements 82, 84, which may be in the form of guide rails having first and second ends, are then inserted into the channels 76, 78 of the spacer gripping elements. One advantage of this configuration is that the spacing between the arrays of the fibers can easily be adjusted by changing the height of the spacing elements 82 and 84. The spacing elements 82, 84 may be made from the same material as the gripping elements, or they may be made from different material. Preferably, the height of the spacing elements 82, 84 is greater than the combined height of the spacer gripping elements that define the channels 76, 78. In other words, the height of the spacing elements 82, 84 should determine the spacing between the sections 52, 54.

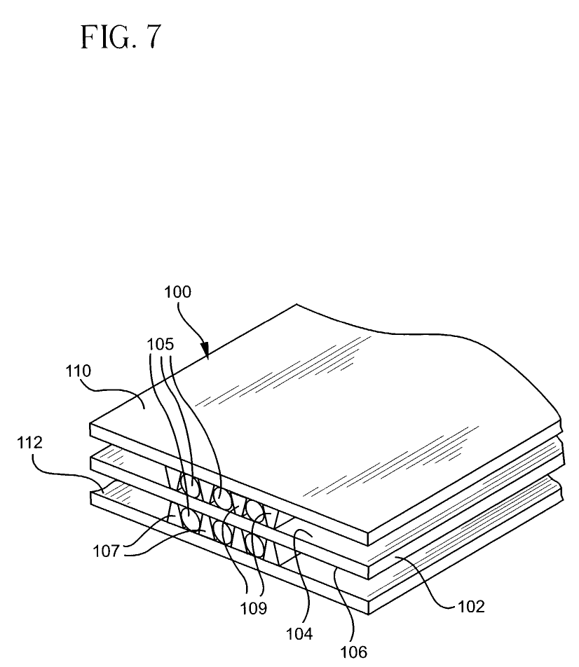

Another embodiment is shown in FIG. 7. According to the embodiment shown in FIG. 8, an article for forming a stacked fiber array 100 includes a substrate 102 having opposite sides or surfaces 104, 106. A first array of gripping elements 109 is formed on surface 104, and a second array of gripping elements 107 is formed on surface 106. The arrays of gripping elements 109 and 107 are adapted to secure optical fibers 105 to the substrate. According to this embodiment, the thickness of substrate 102 serves as a spacer between the arrays of gripping elements 109, 107. The article for forming a stacked fiber array 100 may further include a pair of cover members 110, 112, for sandwiching the first and second arrays of gripping elements.

Another embodiment relates to a method of forming stacked arrays of optical fiber. The method comprises forming first and second arrays of flexible gripping elements on a substrate surface. The flexible gripping elements include a pair of spaced apart sidewalls and defining a channel adapted to grip an optical fiber. The arrays of flexible gripping elements are then arranged in a stacked relationship, and optical fibers are secured in at least a portion of the channels to provide stacked arrays of optical fibers. The arrays of gripping elements are spaced apart preferably by either the substrate itself or by spacer elements such as the guide rails described above. According to some embodiments, the first arrays are attached to a first substrate and the second arrays are attached to a second substrate. Spacing may be provided by inserting a pair of guide rails between the first and second substrates. Alternatively, the method may include attaching the first and second arrays on opposing surfaces of a generally planar substrate and the arrays are separated or spaced apart by the substrate.

According to certain embodiments, the methods and articles of the present invention can be used to manufacture optical devices that incorporate an array of optical fibers. An exemplary optical device can be made by inserting a plurality of optical fibers in a plurality of generally parallel channels formed by pairs of gripping elements on a substrate and securing individual fibers in the channels. In some embodiments, the optical fibers are positioned with respect to an optical element such as a prism including multiple thin film filters, a switching element such as a MEMS switch, an electroholographic switch or a LCD switch.

Examples of optical devices that can be made by incorporating the stacked fiber arrays and methods of the present invention include optical fiber and lens arrays, which are used to couple light between optical fibers and optical devices in optical communication systems. Conventional optical fiber and lens arrays typically include an array of fibers arranged in a silicon v-groove positioning element, and the fiber ends are abutted to a lens array, which can be molded from an appropriate polymeric material. The articles for forming stacked fiber arrays of the present invention will allow greater flexibility in positioning the fibers and ease of construction of stacked fiber arrays. The fibers are positioned over their respective gripping elements formed on a substrate and inserted into the gripping elements and grooves to secure the fibers on the substrate. The articles and methods of the present invention can be used to position opposing arrays of lensed fibers having optical components such as filters and polarizers disposed between the opposing arrays.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. An article for forming a stacked fiber array comprising:
first and second arrays of gripping elements arranged on a substrate surface, each gripping element including at least a pair of flexible sidewalls defining a channel, each array of gripping elements forming a plurality of channels on a surface of the substrate adapted to hold an array of fibers, the arrays of gripping elements arranged in a stacked and spaced apart relation.

2. The article of claim 1, wherein each gripping element comprises a pair of polymeric, generally trapezoidally shaped members.

3. The article of claim 2, wherein the first and second arrays of gripping elements are arranged in an opposed relation.

4. The article of claim 3, wherein the first and second arrays are separated by a spacer.

5. The article of claim 4, wherein the spacer includes a pair of guide rails having first and second ends.

6. The article of claim 5, wherein at least one end of each guide rail is held in place by a gripping element including at least a pair of flexible sidewalls forming a spacer channel adapted to receive the guide rail.

7. The article of claim 6, wherein the spacer and the gripping element are made from the same material.

8. The article of claim 1, wherein the array of gripping elements is arranged to provide a plurality of generally parallel channels adapted to receive an array of optical fibers.

9. The article of claim 4, wherein the first array of gripping elements is attached to a first substrate and the second array of gripping elements is attached to a second substrate.

10. The article of claim 4, wherein the first and second array of gripping elements are attached to the opposite sides of a generally flat substrate and the spacer includes the substrate.

11. The article of claim 10, further including a pair of cover members for sandwiching the first and second arrays of gripping elements.

12. A method of forming stacked arrays of optical fibers comprising:
forming first and second arrays of flexible gripping elements on a substrate surface, each flexible gripping element including a pair of spaced apart sidewalls and defining a channel adapted to grip an optical fiber;
arranging the arrays of flexible gripping elements in a stacked relationship;
securing a plurality of optical fibers in at least a portion of the channels to provide stacked arrays of optical fibers.

13. The method of claim 12, wherein the gripping elements are generally trapezoidally shaped.

14. The method of claim 12, further comprising spacing the first and second arrays of flexible gripping elements.

15. The method of claim 14, further comprising attaching the first arrays to a first substrate and attaching the second arrays to a second substrate and inserting a pair of guide rails between the first and second substrates.

16. The method of claim 15, further comprising attaching the arrays of gripping elements in a generally parallel arrangement.

17. The method of claim 14, further comprising attaching the arrays on opposing surfaces of a generally planar substrate and the arrays are spaced by the substrate.

18. The method of claim 14, further comprising attaching the gripping elements in a generally parallel arrangement.
